(19) United States
(12) Patent Application Publication
(10) Pub. No.: US 2021/0192404 A1
(43) Pub. Date: Jun. 24, 2021

(54) CUMULATIVE SURGED RIDE VALUE CALCULATION ON A RIDESHARING PLATFORM

(71) Applicant: Beijing DiDi Infinity Technology and Development Co., Ltd., Beijing (CN)

(72) Inventor: Bo TAN, Sunnyvale, CA (US)

(21) Appl. No.: 16/720,484

(22) Filed: Dec. 19, 2019

(51) Int. Cl. G06Q 10/06

(52) U.S. Cl. CPC G06Q 10/06311; G06Q 2240/00

(57) ABSTRACT

A cumulative surged ride value may be calculated for trips on a ride sharing platform. A set of segments of a trip of a vehicle on a ridesharing platform may be obtained. The trip may serve a plurality of riders. A personal surge multiplier associated with each of the plurality of riders may be obtained. A driver basic fare for each segment may be obtained. A cumulative ride value may be determined based on the driver basic fare for each segment and the personal surge multiplier associated with each of the plurality of riders.

### TECHNICAL FIELD

The disclosure relates generally to calculating a cumulative surged ride value of a trip on a ride sharing platform.

### BACKGROUND

Ridesharing platforms may match drivers of personal cars or taxis with riders to provide on-demand transportation services. A rider may also be matched with co-riders who travel along similar routes to form a carpooling trip. Carpooling may be very important for cities because it may result in less traffic congestion. Carpooling may also achieve more financial efficiency for the ridesharing platform itself, as cost savings may be obtained through a higher utilization of car resources and drivers' supply hours. Effective carpooling may reduce the cost compared to moving the same amount of riders and demand on a platform without carpooling.

### SUMMARY

Various embodiments of the specification include, but are not limited to, systems, methods, and non-transitory computer readable media for trip monitoring.

In various implementations, a method may include obtaining a set of segments of a trip of a vehicle on a ridesharing platform, wherein the trip serves a plurality of riders. The method may further include obtaining a personal surge multiplier associated with each of the plurality of riders, and obtaining a driver basic fare for each segment. The method may further include determining a cumulative ride value based on the driver basic fare for each segment and the personal surge multiplier associated with each of the plurality of riders.

In another aspect of the present disclosure, a computing system may comprise one or more processors and one or more non-transitory computer-readable memories coupled to the one or more processors and configured with instructions executable by the one or more processors. Executing the instructions may cause the system to perform operations. The operations may include obtaining a set of segments of a trip of a vehicle on a ridesharing platform, wherein the trip serves a plurality of riders. The operations may further include obtaining a personal surge multiplier associated with each of the plurality of riders, and obtaining a driver basic fare for each segment. The operations may further include determining a cumulative ride value based on the driver basic fare for each segment and the personal surge multiplier associated with each of the plurality of riders.

Yet another aspect of the present disclosure is directed to a non-transitory computer-readable storage medium configured with instructions executable by one or more processors to cause the one or more processors to perform operations. The operations may include obtaining a set of segments of a trip of a vehicle on a ridesharing platform, wherein the trip serves a plurality of riders. The operations may further include obtaining a personal surge multiplier associated with each of the plurality of riders, and obtaining a driver basic fare for each segment. The operations may further include determining a cumulative ride value based on the driver basic fare for each segment and the personal surge multiplier associated with each of the plurality of riders.

In some embodiments, each segment in the set of segments may include a starting location and an ending location. The starting and ending locations may be associated with one or more of picking up a rider or dropping a rider off.

In some embodiments, determining a cumulative ride value based on the driver basic fare for each segment and the personal surge multiplier associated with each of the plurality of riders may include obtaining a surge multiplier for each segment based on a number of riders in the vehicle at the end of the each segment and the rider surge multipliers associated with the riders in the vehicle at the end of the each segment. The cumulative ride value may be determined based on the driver basic fare for each segment and the surge multiplier for each segment.

In some embodiments, determining a cumulative ride value based on the driver basic fare for each segment and the surge multiplier for each segment may include obtaining an average surge multiplier for each segment based on the surge multiplier for each segment divided by the number of riders in the vehicle at the end of each segment. A surged fare for each segment may be obtained based on the product of the average surge multiplier for each segment and the driver basic fare for each segment. The surged fare for each segment may be added to the cumulative ride value.

In some embodiments, obtaining the surge multiplier for each segment may include obtaining a weight for each rider in the vehicle at the end of each segment. A rider surge multiplier for each rider may be obtained. A weighted rider surge multiplier for each rider may be obtained based on a product of the weight and the rider surge multiplier. The surge multiplier may be calculated based on a summation of the weighted rider surge multipliers for each rider.

In some embodiments, obtaining the weight for each rider may include obtaining a rider value for each rider. A summation of the rider values may be obtained. The weight for each rider may be calculated based on the rider value for each rider divided by the summation of the rider values.

In some embodiments, the rider value for each rider may include a gross merchandise value collected from each rider.

In some embodiments, the rider value for each rider may include a life time value for each rider.

In some embodiments, determining a cumulative ride value based on the driver basic fare for each segment and the surge multiplier for each segment may include obtaining a surged fare for each segment based on the product of the surge multiplier for each segment and the driver basic fare for each segment. The surged fare for each segment may be added to the cumulative ride value.

In some embodiments, the driver basic fare for each segment may be based on a per-minute fee rate multiplied by the duration of the trip and a per-mile fee rate multiplied by the distance of the trip.

In some embodiments, a set of additional fees may be added to the cumulative ride value.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an exemplary environment to which techniques for cumulative surged ride value calculation may be applied, in accordance with various embodiments.

FIG. 2A illustrates an exemplary block diagram, in accordance with various embodiments.

FIG. 2B illustrates an exemplary block diagram, in accordance with various embodiments.

FIG. 3 illustrates a flowchart of an exemplary method, according to various embodiments of the present disclosure.

FIG. 4A illustrates a flowchart of an example method, according to various embodiments of the present disclosure.

FIG. 4B illustrates a flowchart of an example method, according to various embodiments of the present disclosure.

FIG. 5 is a block diagram that illustrates a computer system upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may improve driver pricing distribution and equivalent driver earnings in ridesharing platforms. Drivers in ridesharing platforms may be paid by time and distance during their travels in providing services. The total amount paid to drivers may additionally consider incentives and other types of additional earnings. The payout to drivers may be calculated independently of how the ridesharing platform charges riders. This principle may be referred to as rider/driver fare decoupling. Fare decoupling may be utilized in order to be fair to drivers. Discounts may be given for rider fares. If the driver fare is coupled with the rider fare, the driver earnings will be “discounted” too, and this will be unfair for the drivers. Fare decoupling may be important for both trips with solo riders and carpool services. Furthermore, fare decoupling may be necessary in carpooling scenarios.

A surge multiplier may be used in fare calculation in addition to the basic fare calculated based on travel time and distance. Surge may be a critical part of driver earnings. A surge multiplier may reflect the supply-demand imbalance in a certain region and time period. In some embodiments, calculations of driver fares may use the following formula:

p=s·(αt+βd)+Δ, (1)

wherein p may represent the driver fare (i.e., a non-incentive part of driver earnings). The surge multiplier may be larger than or equal to one. The surge multiplier may be larger than one in an under-supply scenario, and may equal one in all other scenarios. The surge multiplier may be multiplied by the driver basic fare (αt+βd). The variables α and β may include per-minute and per-mile fee rates, respectively. The variables t and d may include times (e.g., minutes) and distances (e.g., mileage) in a current travel, respectively. The driver basic fare may be calculated using different formulas. For example, the driver basic fare may have a nonlinear relationship with t and d, and other factors may be included. Other additional fees Δ may be added to calculate the driver fares. In some embodiments, the additional fees Δ may be zero. In some embodiments, the additional fees Δ may include pickup fees (e.g., for a certain city) and upgraded services (e.g., for a larger vehicle), a variable estimated time of arrival, and driver incentives.

In some embodiments, the surge multiplier s may be the same for the driver as shown in the rider fare. This surge multiplier may be used in the solo scenario because there is only one rider. In some carpooling embodiments, the surge multiplier of the first rider picked up may be applied over the whole carpool trip. For example, one carpool trip may pick up multiple riders along the way. The surge multiplier of the first rider may be applied for all of the riders on the trip. In some embodiments, the term “first rider” may be used to represent the first rider order. For example, many ridesharing platforms support requesting more than one seat in their carpool service. In some embodiments, “rider” may be used to represent a rider order. One rider order may occupy several seats (e.g., contain multiple riders). From the point of view of the ride sharing platform, the service may be requested from only one rider application. The pickup and the destination points may be the same for each human rider in the rider order. The surge multiplier may be applied on a per-order base and function the same as counting only one rider.

In some embodiments, multiple rider orders may be picked up from the same location. For example, before a ride begins, the ridesharing service may let riders choose a walking option or the walking option may be determined by a matching algorithm. The first rider surge multiplier may correspond with the rider at the given pickup location, or the rider at the rider's original departure location. In some embodiments, multiple riders may walk to the same pickup location from different original departure locations, and the multipliers of the original locations may have different values. Any value may be used for the surge multiplier (e.g., a maximum value, a minimum value, an average value, or a random rider surge multiplier of a rider in the vehicle).

The first rider's surge approach may mimic the driver earnings achieved by a solo trip of the whole carpool travel only serving one rider. However, this approach creates the drawback that the surge multiplier is locked at the beginning of the travel. Later orders may be matched along the way of a pool travel. There may not be a chance for the driver to get a higher surge multiplier for the later orders until the pool travel finishes. As a result, the driver's earnings may be reduced compared to serving several equivalent independent solo trips.

While there is a chance that the surge multiplier of the first rider order may be very high and the driver actually may earn more, using the first rider's surge approach creates uncertainty for the driver's earnings. It may not be feasible to statistically guarantee that the percentage of pool travels with a high first surge multiplier will even out with travels with a low first surge multiplier. Locking the surge multiplier may result in difficulty for drivers to control their earnings. This may be true even with the use of tools such as heatmaps of surges and driver positioning strategies. Drivers may lose interest in serving carpools and may prefer to serve solo trips. Increasing carpool services may improve the ridesharing platform's efficiency and may reduce city congestion. A more fair value for the driver fare may be achieved by calculating cumulative surged ride value in a more rigorous and economic way.

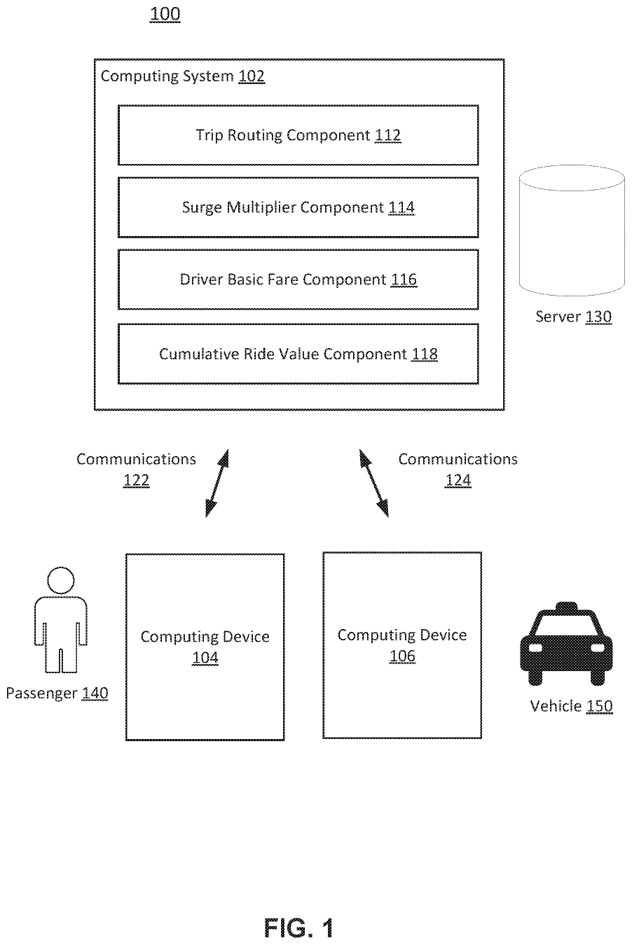

FIG. 1 illustrates an exemplary system 100 to which techniques for cumulative surged ride value calculation may be applied, in accordance with various embodiments. The exemplary system 100 may include a computing system 102, a computing device 104, and a computing device 106. It is to be understood that although two computing devices are shown in FIG. 1, any number of computing devices may be included in the system 100. Computing system 102 may be implemented in one or more networks (e.g., enterprise networks), one or more endpoints, one or more servers, or one or more clouds. A server may include hardware or software which manages access to a centralized resource or service in a network. A cloud may include a cluster of servers and other devices which are distributed across a network.

The computing devices 104 and 106 may be implemented on or as various devices such as a mobile phone, tablet, server, desktop computer, laptop computer, vehicle (e.g., car, truck, boat, train, autonomous vehicle, electric scooter, electric bike), etc. The computing system 102 may communicate with the computing devices 104 and 106, and other computing devices. Computing devices 104 and 106 may communicate with each other through computing system 102, and may communicate with each other directly. Communication between devices may occur over the internet, through a local network (e.g., LAN), or through direct communication (e.g., BLUETOOTH™, radio frequency, infrared).

In some embodiments, the system 100 may include a ride-hailing platform. The ride-hailing platform may facilitate transportation service by connecting drivers of vehicles with passengers. The platform may accept requests for transportation from passengers, identify idle vehicles to fulfill the requests, arrange for pick-ups, and process transactions. For example, passenger 140 may use the computing device 104 to order a trip. The trip order may be included in communications 122. The computing device 104 may be installed with a software application, a web application, an API, or another suitable interface associated with the ride-hailing platform.

The computing system 102 may receive the request and reply with price quote data and price discount data for one or more trips. The price quote data and price discount data for one or more trips may be included in communications 122. When the passenger 140 selects a trip, the computing system 102 may relay trip information to various drivers of idle vehicles. The trip information may be included in communications 124. For example, the request may be posted to computing device 106 carried by the driver of vehicle 150, as well as other commuting devices carried by other drivers. The driver of vehicle 150 may accept the posted transportation request. The acceptance may be sent to computing system 102 and may be included in communications 124. The computing system 102 may send match data to the passenger 140 through computing device 104. The match data may be included in communications 122. The match data may also be sent to the driver of vehicle 150 through computing device 106 and may be included in communications 124. The match data may include pick-up location information, fees, passenger information, driver information, and vehicle information. The matched vehicle may then be dispatched to the requesting passenger. The fees may include transportation fees and may be transacted among the system 102, the computing device 104, and the computing device 106. The fees may be included in communications 122 and 124.

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. The computing system 102 may include a trip routing component 112, a surge multiplier component 114, a driver basic fare component 116, and a cumulative ride value component 118. The computing system 102 may include other components. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and one or more memories (e.g., permanent memory, temporary memory, non-transitory computer-readable storage medium). The one or more memories may be configured with instructions executable by the one or more processors. The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other devices of the system 100.

The trip routing component 112 may be configured to obtain a set of segments of a trip of a vehicle on a ridesharing platform. The trip may serve a plurality of riders. In some embodiments, the trip may include a carpool travel with multiple ride orders from multiple riders. In some embodiments, each segment in the set of segments may include a starting location and an ending location. The starting and ending locations may be associated with one or more of picking up a rider or dropping a rider off. Pick-up spots may include a set of origins {Oi} and drop-off spots may include a set of destinations {Di}, where i represents the i-th rider order. A segment may be located between each two adjacent spots. A carpool travel may be composed of K segments. When there are N rider orders in total and no two rider orders have the same pickup or drop-off locations, K=2N−1.

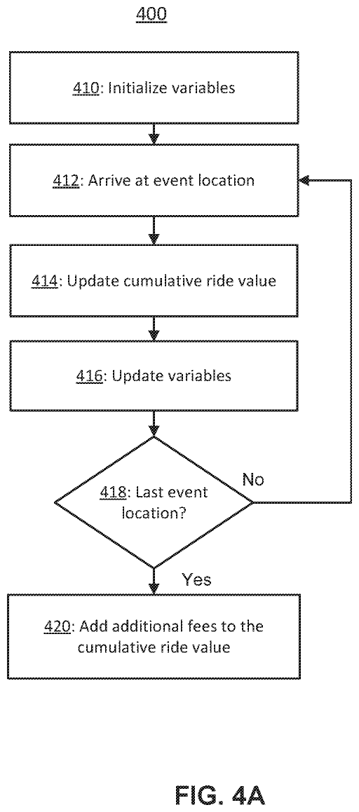

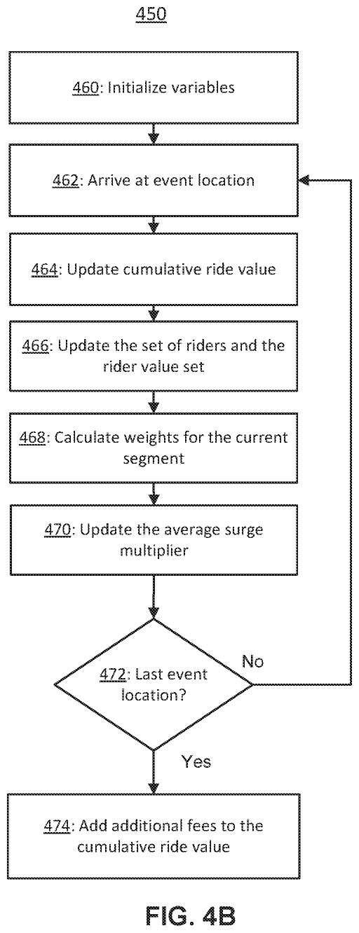

The surge multiplier component 114 may further be configured to obtain a personal surge multiplier associated with each of the plurality of riders. In some embodiments, a surge multiplier for each segment may be obtained based on a number of riders in the vehicle at the end of the each segment and the rider surge multipliers associated with the riders in the vehicle at the end of the each segment. The riders in the vehicle at the end of the each segment may include the riders in the vehicle right before the segment ends. For example, the riders in the vehicle at the end of the each segment may include riders which get dropped off at the end of the segment, and may not include riders which get picked up at the end of the segment. In some a running count of the number of riders may be maintained. The counter may increment when a rider is picked up and may decrement when a rider is dropped off. For example, the counter may be adjusted according to block 416 described below with reference to FIG. 4A.

In some embodiments, obtaining the surge multiplier for each segment may include obtaining a weight for each rider in the vehicle at the end of each segment. A rider surge multiplier for each rider may be obtained. A weighted rider surge multiplier for each rider may be obtained based on a product of the weight and the rider surge multiplier. The surge multiplier may be calculated based on a summation of the weighted rider surge multipliers for each rider. For example, the surge multiplier may be calculated using equation (12) described below with reference to FIG. 4B.

In some embodiments, obtaining the weight for each rider may include obtaining a rider value for each rider. A summation of the rider values may be obtained. The weight for each rider may be calculated based on the rider value for each rider divided by the summation of the rider values. For example, the weight for rider i on the k-th segment may be calculated as the following:

$${w}_{ik} = {v}_{i} / {\sum }_{j ∈ k} {v}_{j} , for i ∈ k , otherwise 0 , \qquad ( 2 )$$

wherein the notation i∈k indicates that rider i's trip goes along segment k. The weight may be a normalized value, and may be normalized by a sum of values vⱼ for each rider j through the corresponding segment. Each value vⱼ may be the same as a value vᵢ for the same rider. The rider value vᵢ may be any quantity or a function of quantities which may justify the economic value of rider i. In some embodiments, the rider values vᵢ's of the riders currently in the car may be tracked when segment sharing is non-uniform. In some embodiments, the rider values may be normalized to calculate the weights according to the respective proportions. An running average surge multiplier may be maintained.

Non-uniform segment sharing may require more data (e.g., a set of rider values {vᵢ}). In some embodiments, the rider value for each rider may include a gross merchandise value (GMV) collected from each rider. The GMV may include a real-time value collected from the rider i (e.g., the rider fare). In some embodiments, the GMV may include an average GMV. The average GMV may be updated after every trip the rider orders, once a day, once a week, once a month, etc. In some embodiments, the GMV may be stored in a cache during a rider upfront pricing flow before the trip begins. The GMV may be fetched from the cache when the weight for the rider is calculated. In some embodiments, the rider value for each rider may include a life time value (LTV) for each rider. The LTV may include an offline value and may not be updated as frequently as the GMV. In some embodiments, the LTV may include a personalized quantity. The LTV may be fetched from a feature store which may store the rider's profile data.

The driver basic fare component 116 may be configured to obtain a driver basic fare for each segment. In some embodiments, the driver basic fare for each segment may be based on a per-minute fee rate multiplied by the duration of the trip and a per-mile fee rate multiplied by the distance of the trip. For example, the driver basic fare in segment k may be calculated as:

Cₖ=αtₖ+βdₖ, (3)

where Cₖ may represent the driver basic fare for the k-th segment. While a linear formulation is used in equation (3), the driver basic fare may be calculated using different formulas. For example, Cₖ may have a nonlinear relationship with tₖ and dₖ, and other factors may be included. The variables α and β may include time based and distance based fee rates, respectively. The variables tₖ and dₖ may include times (e.g., minutes) and distances (e.g., mileage) in a current travel in segment k, respectively.

The cumulative ride value component 118 may be configured to determine a cumulative ride value based on the driver basic fare for each segment and the personal surge multiplier associated with each of the plurality of riders. In some embodiments, a cumulative ride value may be determined based on the driver basic fare for each segment and the surge multiplier for each segment. In some embodiments, determining a cumulative ride value based on the driver basic fare for each segment and the surge multiplier for each segment may include obtaining an average surge multiplier for each segment based on a sum of the rider surge multipliers over each segment divided by the number of riders in the vehicle at the end of each segment. A surged fare for each segment may be obtained based on the product of the average surge multiplier for each segment and the driver basic fare for each segment. The surged fare for each segment may be added to the cumulative ride value.

In some embodiments, determining a cumulative ride value based on the driver basic fare for each segment and the surge multiplier for each segment may include obtaining a surged fare for each segment based on the product of the surge multiplier for each segment and the driver basic fare for each segment. The surged fare for each segment may be added to the cumulative ride value. In some embodiments, a set of additional fees may be added to the cumulative ride value. In some embodiments, the additional fees may be zero. In some embodiments, the additional fees may include pickup fees (e.g., for a certain city) and upgraded services (e.g., for a larger vehicle), a variable estimated time of arrival, and driver incentives.

In some embodiments, the fare calculation approach of determining the cumulative ride value may be shown in a fare detail page. Common ridesharing platforms may have detailed fare (or receipt) pages available in their driver app, showing all the itemized money quantities and how they are calculated. The fare calculation approach may be updated on the fare detail page. For example, the fare calculation approach may be shown in a ridesharing application of the driver on computing device 106.

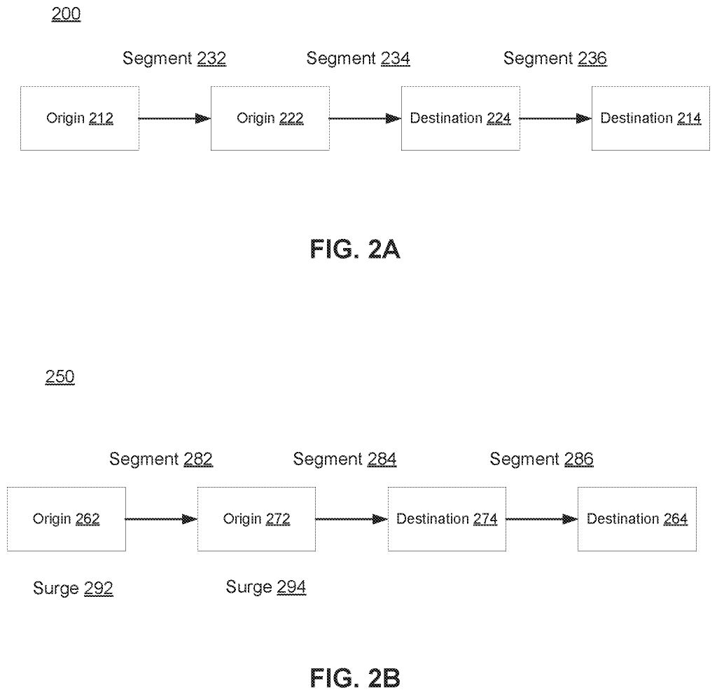

FIG. 2A illustrates an exemplary block diagram 200, in accordance with various embodiments. Block diagram 200 may represent a carpooling trip including two ride orders in a ridesharing platform. The first ride order may request a trip from origin 212 to destination 214. The second ride order may request a trip from origin 222 to destination 224. The carpooling trip may include segments 232-236. The segment 232 may be between the origin 212 of the first ride order and the origin 222 of the second ride order. The segment 234 may be between the origin 222 of the second ride order and the destination 224 of the second ride order. The segment 236 may be between the destination 224 of the second ride order and the destination 214 of the first ride order.

In some embodiments, a driver's basic fare may be allocated across all rider trips as a rider-separable fare. The allocation may be based on each shared travel segment and may avoid double-counting the mileage and distance shared by the riders. The rider-separable fare may not be a real charge for the rider, since the riders may be charged by the amount given in the rider pricing strategy which is decoupled from the driver fare. The rider-separable fare corresponding to rider i may be defined as:

rider_separable_fare[i]=Σ_{k=s[i]}^{e[i]}Cₖ/Nₖ, (4)

where Cₖ may represent the driver basic fare as described in equation (3) above, and Nₖ may represent the number of riders which share the k-th segment. The variables s[i] and e[i] may represent the starting and ending segments for rider i, respectively.

In some embodiments, a rider-separable fare may be calculated from the first and second ride orders. For example, the driver basic fare may be $5 for each of segments 232-236. Both rider orders may share segment 234. The rider-separable fare for the first rider order may be calculated as:

rider_separable_fare[1]=$5+$5/2+$5=$12.5. (5)

The rider-separable fare for the second rider order may be calculated as:

rider_separable_fare[2]=$5/2=$2.5. (6)

The sum of the rider-separable fare may equal $15, which may match the driver's basic fare for the whole carpooling trip.

FIG. 2B illustrates an exemplary block diagram 250, in accordance with various embodiments. Block diagram 250 may represent a carpooling trip including two ride orders in a ridesharing platform. The first ride order may request a trip from origin 262 to destination 264 and may include surge 292. For example, surge 292 may be 1.2× (i.e., the surged fare may be 1.2 times the driver basic fare). The second ride order may request a trip from origin 272 to destination 274 and may include surge 294. For example, surge 294 may be 1.5× (i.e., the surged fare may be 1.2 times the driver basic fare). The carpooling trip may include segments 282-286. The segment 282 may be between the origin 262 of the first ride order and the origin 272 of the second ride order. The segment 284 may be between the origin 272 of the second ride order and the destination 274 of the second ride order. The segment 286 may be between the destination 274 of the second ride order and the destination 264 of the first ride order.

In some embodiments, the surged driver fare may be calculated as the weighted sum of rider separable fares, where the weight is the surge multiplier at the corresponding rider's pickup location. The surged driver fare may be calculated as:

driver_fare=Σᵢsᵢ·rider_separable_fare[i]+additional_fees (7)

where sᵢ may be the surge multiplier affiliated with the i-th rider. If the additional fee is zero, the driver price may be calculated as:

$$\begin{matrix}driver\_price = 1.2 * rider\_separable \_fare [ 1 ] + \\ 1.5 * rider\_separable \_fare [ 2 ] + 0 \\ = 1.2 * \$12 .5 + 1.5 * \$2 .5 \\ = \$18 .75 .\end{matrix} \qquad ( 8 )$$

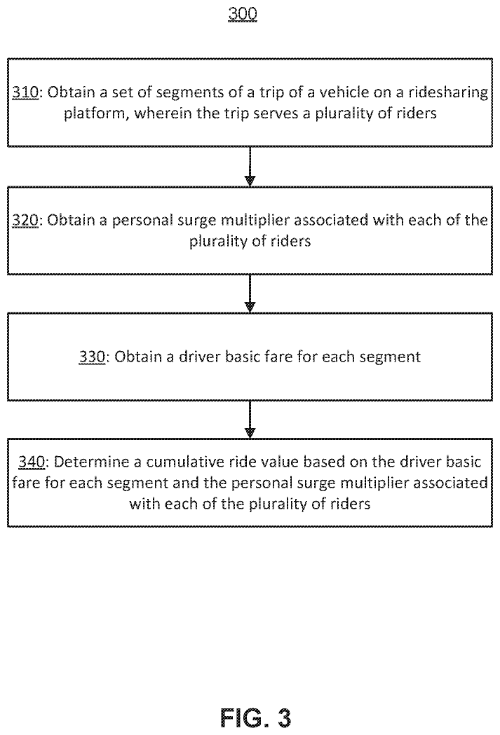

FIG. 3 illustrates a flowchart of an exemplary method 300, according to various embodiments of the present disclosure. The method 300 may be implemented in various environments including, for example, the system 100 of FIG. 1. The method 300 may be performed by computing system 102. The operations of the method 300 presented below are intended to be illustrative. Depending on the implementation, the method 300 may include additional, fewer, or alternative steps performed in various orders or in parallel. The method 300 may be implemented in various computing systems or devices including one or more processors.

With respect to the method 300, at block 310, a set of segments of a trip of a vehicle on a ridesharing platform may be obtained. The trip may serve a plurality of riders. At block 320, a personal surge multiplier associated with each of the plurality of riders may be obtained. At block 330, a driver basic fare for each segment may be obtained. At block 340, a cumulative ride value may be determined based on the driver basic fare for each segment and the personal surge multiplier associated with each of the plurality of riders.

FIG. 4A illustrates a flowchart of an exemplary method 400, according to various embodiments of the present disclosure. The method 400 may be performed in embodiments in which segment sharing is uniform. The method 400 may be implemented in various environments including, for example, the system 100 of FIG. 1. The method 400 may be performed by computing system 102. The operations of the method 400 presented below are intended to be illustrative. Depending on the implementation, the method 400 may include additional, fewer, or alternative steps performed in various orders or in parallel. The method 400 may be implemented in various computing systems or devices including one or more processors.

With respect to the method 400, at block 410, variables may be initialized. The variables may include a number of ride orders on the car N, a sum of surge multipliers which belong to the N rider orders S, and the cumulative ride value P. In some embodiments, N and S may be initialized to 0 at the beginning of a pool travel. This may occur after a driver has been matched with at least one carpool service request. The variables may be initialized in an application of the driver and/or a related backend system. At block 412, the vehicle may arrive at an event location. The event location may include a pickup or drop-off location. A pickup event may include picking up a rider i, and a drop-off event may include dropping off a rider i.

Update events may be performed for each event location. At block 414, the cumulative ride value may be updated. In some embodiments, the cumulative ride value P may be updated based on:

$$P : = P + \frac{S}{N} \cdot {C}_{k} , \qquad ( 9 )$$

where Cₖ may represent the driver basic fare for the segment k which the car has just travelled (i.e., the segment between the current event location and the previous event location). The initial driver basic fare may be set as C₀=0 (i.e., adding 0 at the beginning of the travel). At block 416, the variables may be updated. When the event includes picking up a rider i, the count of the number of riders may be updated as N:=N+1, and the sum of surge multipliers may be updated as S:=S+s[i]. When the event includes dropping off a rider i, the count of the number of riders may be updated as N:=N−1, and the sum of surge multipliers may be updated as S:=S−s[i].

At block 418, it may be determined whether the vehicle has reached the last event location. If there are more event locations on the travel, the updating events may be repeated for the next event location. If there are no more event locations and the vehicle has reached the end of the travel, the process may advance to block 420. At block 420, additional fees may be added to the cumulative ride value.

FIG. 4B illustrates a flowchart of an exemplary method 450, according to various embodiments of the present disclosure. The method 450 may be performed in embodiments in which segment sharing is non-uniform. The method 450 may be implemented in various environments including, for example, the system 100 of FIG. 1. The method 450 may be performed by computing system 102. The operations of the method 450 presented below are intended to be illustrative. Depending on the implementation, the method 450 may include additional, fewer, or alternative steps performed in various orders or in parallel. The method 400 may be implemented in various computing systems or devices including one or more processors.

With respect to the method 450, at block 460, variables may be initialized. The variables may include a set of riders R, a rider value set V, an average surge multiplier s̅, and the cumulative ride value P. In some embodiments, R and V may be initialized to be empty sets, and s̅ may be initialized to be 0 at the beginning of a pool travel. This may occur after a driver has been matched with at least one carpool service request. The variables may be initialized in an application of the driver and/or a related backend system. At block 462, the vehicle may arrive at an event location. The event location may include a pickup or drop-off location. A pickup event may include picking up a rider i, and a drop-off event may include dropping off a rider i.

Update events may be performed for each event location. At block 464, the cumulative ride value may be updated. In some embodiments, the cumulative ride value P may be updated based on:

P:=P+s̅·Cₖ, (10)

where Cₖ may represent the driver basic fare for the segment k which the car has just travelled (i.e., the segment between the current event location and the previous event location). The initial driver basic fare may be set as C₀=0 (i.e., adding 0 at the beginning of the travel). At block 466, the set of riders and the rider value set may be updated. When the event includes picking up a rider i, rider i may be added into the set of riders R, and a rider value vᵢ for rider i may be added into the rider value set V. When the event includes dropping off a rider i, rider i may be removed from the set of riders R, and the rider value vᵢ for rider i may be removed from the rider value set V.

At block 468, weights for the current segment may be calculated. In some embodiments, a weight wᵢ may be calculated for each rider i as:

$$∀ i ∈ R , {w}_{i} : = {v}_{i} / {\sum }_{j ∈ R} {v}_{j} \qquad ( 11 )$$

where vⱼ may represent a value for rider j. At block 470, the average surge multiplier may be updated. In some embodiments, the average surge multiplier s̅, may be updated as:

$$\overline{s} = {\sum }_{i ∈ R} {w}_{i} \cdot {s}_{i} \qquad ( 12 )$$

where sᵢ may represent a surge multiplier for rider i. At block 472, it may be determined whether the vehicle has reached the last event location. If there are more event locations on the travel, the updating events may be repeated for the next event location. If there are no more event locations and the vehicle has reached the end of the travel, the process may advance to block 474. At block 474, additional fees may be added to the cumulative ride value.

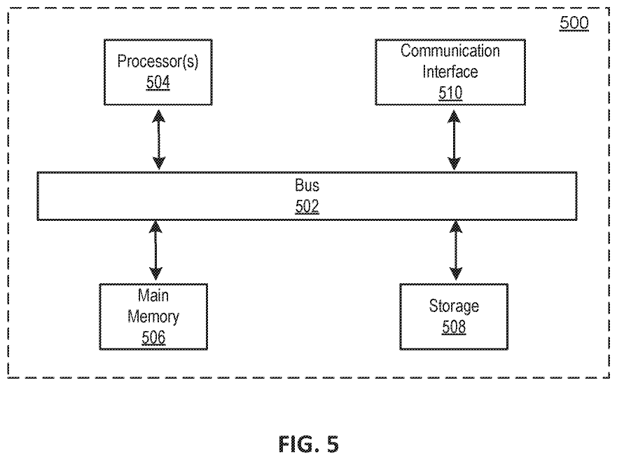

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein.

For example, the computing system 500 may be used to implement the computing system 102, the trip routing component 112, the surge multiplier component 114, the driver basic fair component 116, and the cumulative ride value component 118. shown in FIG. 1. As another example, the process/method shown in FIGS. 3-4B and described in connection with this figure may be implemented by computer program instructions stored in main memory 506. When these instructions are executed by processor(s) 504, they may perform the steps of methods 300, 400, and 450 as shown in FIG. 3-4B and described above. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may comprise instructions which may program or configure the computing system 102 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A method for cumulative surged ride value calculation, comprising:
obtaining a set of segments of a trip of a vehicle on a ridesharing platform, wherein the trip serves a plurality of riders;
obtaining a personal surge multiplier associated with each of the plurality of riders;
obtaining a driver basic fare for each segment; and
determining a cumulative ride value based on the driver basic fare for each segment and the personal surge multiplier associated with each of the plurality of riders.

2. The method of claim 1, wherein each segment in the set of segments comprises a starting location and an ending location, wherein the starting and ending locations are associated with one or more of picking up a rider or dropping a rider off.

3. The method of claim 1, wherein the determining a cumulative ride value based on the driver basic fare for each segment and the personal surge multiplier associated with each of the plurality of riders comprises:
obtaining a surge multiplier for each segment based on a number of riders in the vehicle at the end of the each segment and the rider surge multipliers associated with the riders in the vehicle at the end of the each segment; and
determining the cumulative ride value based on the driver basic fare for each segment and the surge multiplier for each segment.

4. The method of claim 3, wherein determining a cumulative ride value based on the driver basic fare for each segment and the surge multiplier for each segment comprises:
obtaining an average surge multiplier for each segment based on a sum of the rider surge multipliers over each segment divided by the number of riders in the vehicle at the end of each segment;
obtaining a surged fare for each segment based on the product of the average surge multiplier for each segment and the driver basic fare for each segment; and
adding the surged fare for each segment to the cumulative ride value.

5. The method of claim 3, wherein obtaining the surge multiplier for each segment comprises:
obtaining a weight for each rider in the vehicle at the end of each segment;
obtaining a rider surge multiplier for each rider;
obtaining a weighted rider surge multiplier for each rider based on a product of the weight and the rider surge multiplier; and
calculating the surge multiplier based on a summation of the weighted rider surge multipliers for each rider.

6. The method of claim 5, wherein obtaining the weight for each rider comprises:
obtaining a rider value for each rider;
obtaining a summation of the rider values; and
calculating the weight for each rider based on the rider value for each rider divided by the summation of the rider values.

7. The method of claim 6, wherein the rider value for each rider comprises a gross merchandise value collected from each rider.

8. The method of claim 6, wherein the rider value for each rider comprises a life time value for each rider.

9. The method of claim 5, wherein determining a cumulative ride value based on the driver basic fare for each segment and the surge multiplier for each segment comprises:
obtaining a surged fare for each segment based on the product of the surge multiplier for each segment and the driver basic fare for each segment; and
adding the surged fare for each segment to the cumulative ride value.

10. The method of claim 1, wherein the driver basic fare for each segment is based on a per-minute fee rate multiplied by the duration of the trip and a per-mile fee rate multiplied by the distance of the trip.

11. The method of claim 1, the method further comprising: adding a set of additional fees to the cumulative ride value.

12. A system for cumulative surge ride value calculation, comprising one or more processors and one or more non-transitory computer-readable memories coupled to the one or more processors and configured with instructions executable by the one or more processors to cause the system to perform operations comprising:
obtaining a set of segments of a trip of a vehicle on a ridesharing platform, wherein the trip serves a plurality of riders;
obtaining a personal surge multiplier associated with each of the plurality of riders;
obtaining a driver basic fare for each segment; and
determining a cumulative ride value based on the driver basic fare for each segment and the personal surge multiplier associated with each of the plurality of riders.

13. The system of claim 12, wherein the determining a cumulative ride value based on the driver basic fare for each segment and the personal surge multiplier associated with each of the plurality of riders comprises:
obtaining a surge multiplier for each segment based on a number of riders in the vehicle at the end of the each segment and the rider surge multipliers associated with the riders in the vehicle at the end of the each segment; and
determining the cumulative ride value based on the driver basic fare for each segment and the surge multiplier for each segment.

14. The system of claim 13, wherein determining a cumulative ride value based on the set driver basic fares and the set of surge multipliers comprises:
obtaining an average surge multiplier for each segment based on a sum of the rider surge multipliers over each segment divided by the number of riders in the vehicle at the end of each segment;
obtaining a surged fare for each segment based on the product of the average surge multiplier for each segment and the driver basic fare for each segment; and
adding the surged fare for each segment to the cumulative ride value.

15. The system of claim 13, wherein obtaining the surge multiplier for each segment comprises:
obtaining a weight for each rider in the vehicle at the end of each segment;
obtaining a rider surge multiplier for each rider;
obtaining a weighted rider surge multiplier for each rider based on a product of the weight and the rider surge multiplier; and
calculating the surge multiplier based on a summation of the weighted rider surge multipliers for each rider.

16. The system of claim 15, wherein obtaining the weight for each rider comprises:
obtaining a rider value for each rider;
obtaining a summation of the rider values; and
calculating the weight for each rider based on the rider value for each rider divided by the summation of the rider values.

17. The system of claim 15, wherein determining a cumulative ride value based on the set driver basic fares and the set of surge multipliers comprises:
obtaining a surged fare for each segment based on the product of the surge multiplier for each segment and the driver basic fare for each segment; and
adding the surged fare for each segment to the cumulative ride value.

18. A non-transitory computer-readable storage medium configured with instructions executable by one or more processors to cause the one or more processors to perform operations comprising:
obtaining a set of segments of a trip of a vehicle on a ridesharing platform, wherein the trip serves a plurality of riders;
obtaining a personal surge multiplier associated with each of the plurality of riders;
obtaining a driver basic fare for each segment; and
determining a cumulative ride value based on the driver basic fare for each segment and the personal surge multiplier associated with each of the plurality of riders.

19. The non-transitory computer-readable storage medium of claim 18, wherein determining a cumulative ride value based on the set driver basic fares and the set of surge multipliers comprises:
obtaining a surge multiplier for each segment based on a number of riders in the vehicle at the end of the each segment and the rider surge multipliers associated with the riders in the vehicle at the end of the each segment;
obtaining an average surge multiplier for each segment based on the surge multiplier for each segment divided by the number of riders in the vehicle at the end of each segment,
wherein the surge multiplier for each segment is based on a summation of rider surge multipliers for each rider in the vehicle at the end of each segment;
obtaining a surged fare for each segment based on the product of the average surge multiplier for each segment and the driver basic fare for each segment; and
adding the surged fare for each segment to the cumulative ride value.

20. The non-transitory computer-readable storage medium of claim 18, wherein determining a cumulative ride value based on the driver basic fare for each segment and the surge multiplier for each segment comprises:
obtaining a weight for each rider in the vehicle at the end of each segment;
obtaining a rider surge multiplier for each rider;
obtaining a weighted rider surge multiplier for each rider based on a product of the weight and the rider surge multiplier;
calculating the surge multiplier for each segment based on a summation of the weighted rider surge multipliers for each rider;
obtaining a surged fare for each segment based on the product of the surge multiplier for each segment and the driver basic fare for each segment; and
adding the surged fare for each segment to the cumulative ride value.
